(19) United States
(12) Patent Application Publication
(10) Pub. No.: US 2026/0301408 A1
(43) Pub. Date: Oct. 1, 2026

(54) TRUST LEVEL UPDATE SYSTEM

(71) Applicant: TOSHIBA GLOBAL COMMERCE SOLUTIONS, INC., Durham, NC (US)

(72) Inventors: Yevgeni TSIRULNIK, Frisco, TX (US); James L. FRANK, Montreal (CA)

(21) Appl. No.: 19/094,334

(22) Filed: Mar. 28, 2025

(51) Int. Cl. G06V 20/52; G06T 7/11; G06V 40/20

(52) U.S. Cl. CPC G06V 20/52; G06T 7/11; G06V 40/28

(57) ABSTRACT

A computer-implemented method, computer system, and computer program product are described, where the computer-implemented method includes detecting, using sensor(s), a person within an environment, and determining, responsive to determining that the person is registered with an operator of the environment, a first trust value for a trust level associated with the person. The computer-implemented method further includes, responsive to determining that the first trust value is greater than a predetermined threshold, transmitting a control signal to an access control device that is attached to a door or cover and that controls access to the first secure region. The control signal includes an instruction causing the access control device to actuate a latch in a direction that releases the latch from a detent associated with the first secure region, enabling movement of the door or cover relative to the trust level meeting the predetermined threshold.

### BACKGROUND

Many modern environments such as retail stores, warehouses, industrial facilities, museums, libraries, and so forth are sensor-enabled to permit operators of the environments to detect and identify persons and objects located therein, to track movement of the persons and objects, and to identify interactions occurring between the various entities. These functions can improve safety and efficiency within the environment, prevent theft and waste, and so forth.

### BRIEF DESCRIPTION OF THE SEVERAL VIEWS OF THE DRAWINGS

FIG. 1 is an exemplary system for dynamically updating a trust level for a person based on behavior while accessing a secure region, according to one or more embodiments.

FIG. 2 is an exemplary method of dynamically updating a trust level for a person based on behavior while accessing a secure region, according to one or more embodiments.

FIGS. 3A and 3B illustrate an exemplary sequence of a person accessing secure regions within an environment, according to one or more embodiments.

### DETAILED DESCRIPTION

Within a retail environment, high-value items or other items that are targeted for theft may be secured using physical barriers, such as being stored within locked cases. Other theft prevention techniques include personnel-based solutions like assigning and/or communicating with store associates or security personnel. Yet another technique includes using electronic article surveillance (EAS) that triggers an alarm when unpaid items cross store boundaries. However, all of these techniques can pose challenges such as presenting an inconvenience to customers, being subject to human error, or exhibiting limited effectiveness.

A system is described herein that supports a sensor-enabled environment that can detect persons, identify them, and track their behaviors and interactions while they traverse the environment. According to one or more embodiments, a trust value is associated with each person and dynamically updated according to the person’s behaviors and interactions. When the person’s trust value is greater than a threshold, the person approaching a secure region within the environment is granted access to the secure region by controlling access control device(s) for the secure region, e.g., disabling a lock or retention mechanism by actuating a latch in a direction that releases the latch from a detent associated with the secure region. The trust value is updated based on behavior(s) of the person when accessing the secure region. In this way, the system ensures item security while providing an enhanced experience for the person, reducing a need for assistance by an associate to access high-value items.

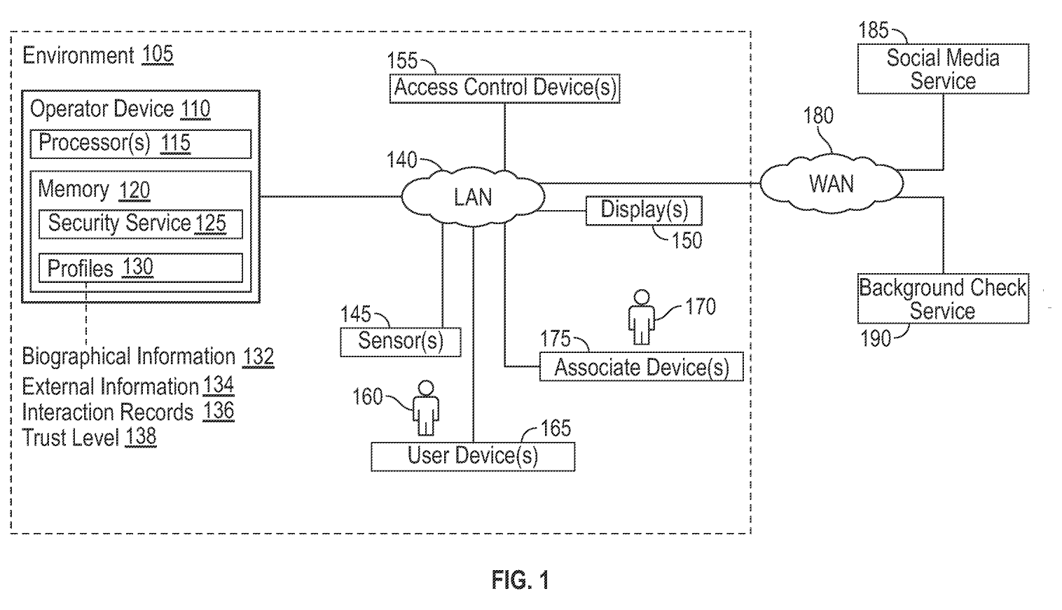

FIG. 1 is an exemplary system 100 for dynamically updating a trust level for a person based on behavior while accessing a secure region, according to one or more embodiments. The system 100 may be operated by an operator of an environment 105 to provide various functionality and/or management thereto. While the environment 105 is generally discussed within the context of a shopping environment, such as a retail store or other commercial environment, it is contemplated that the techniques disclosed herein may be applied to other environments (some non-limiting examples include libraries, museums, classrooms, hospitals, etc.) to provide a similar experience for persons included therein.

The environment 105 includes a plurality of electronic devices that are communicatively connected by a local area network (LAN) 140. As shown, the plurality of electronic devices includes an operator device 110, one or more user devices 165, and one or more associate devices 175. The LAN 140 is designed to communicate data between electronic devices located in a local area, such as a Wi-Fi network. The LAN 140 typically includes computer hardware such as copper transmission cables, optical transmission fibers, wireless transmission, routers, firewalls, switches, gateway computers, and/or edge servers.

As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network (e.g., the LAN 140). An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth.

The electronic device comprises one or more processors and a memory. For example, the operator device 110 is shown as including one or more processors 115 and a memory 120. The one or more processors represent any electronic circuitry, including, but not limited to one or a combination of microprocessors, microcontrollers, application-specific integrated circuits (ASIC), application-specific instruction set processors (ASIP), and/or state machines, that is communicatively coupled to the memory and controls the operation of the system. In some aspects, the electronic circuitry is configured to perform any of the functions described herein. Further, the one or more processors are not limited to a single processing device and may encompass multiple processing devices.

The one or more processors may include other hardware that operates software to control and process information. In some aspects, the one or more processors execute software stored in the memory to perform any of the functions described herein. The one or more processors control the operation and administration of the electronic device by processing information (e.g., information received from input devices and/or communicatively coupled electronic devices).

The memory may store, either permanently or temporarily, data, operational software, or other information for the one or more processors. The memory may include any one or a combination of volatile or non-volatile local or remote devices suitable for storing information. For example, the memory may include random-access memory (RAM), read-only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory, a disk, a CD, or a flash drive. In particular embodiments, the software may include an application executable by the one or more processors to perform one or more of the functions described herein.

The memory 120 of the operator device 110 includes a security service 125 that provides various security functionality to the environment 105. In some embodiments, the security service 125 manages one or more secure regions that are defined within the environment 105 and that provide controlled access to age-restricted items, high-value items, controlled substances or other regulated items, and so forth. More specifically, the security service 125 is communicatively connected to one or more access control devices 155, such as locks or retention mechanisms, that are operated to enable or disable physical barriers to the secure regions. The one or more secure regions may be implemented in any suitable form, such as shelving units having lockable doors or drawers, display cases or units, rooms or portions thereof, refrigerated or other environmentally-controlled spaces, enclosed containers such as a safe or beverage cooler, and so forth.

The one or more access control devices 155 may be implemented in any suitable form. Some non-limiting examples include a smart lock having a motor that actuates a latch (e.g., a deadbolt) into and out of a detent (e.g., a doorframe), an electromagnetic lock having an armature plate (e.g., attached to a door or cover) that is held stationary by an electromagnet, an electric strike plate that actuates relative to a latch bolt, a motorized sliding bolt, an electromechanical hinge that is motorized or includes an actuable pin to restrict motion, an actuable barrier having a motor or hydraulic actuator, an actuable door or cover (or portion thereof) having a linear actuator or motor, and so forth. Further, multiple access control devices may be used in combination with each other at a secure region, and in some cases may be of different types (e.g., an electromechanical hinge and a motorized deadbolt on a same door).

The security service 125 provides several functions within the environment 105: operating one or more sensors 145, performing computer vision on obtained imagery to identify and/or track persons and items in the environment 105, performing behavior assessment of the persons, dynamically calculating trust levels associated with persons in the environment 105, and generating control signals to operate the one or more access control devices 155 in accordance with the trust levels. In other implementations, the security service 125 may provide additional functionality, and/or some of the functionality of the security service 125 may be distributed among multiple services (e.g., operating on the operator device 110 and/or other communicatively connected electronic device(s)).

The one or more sensors 145 may have any suitable type(s), such as visual sensors (e.g., sensing visible light, low light, and/or infrared light) capable of obtaining imagery depicting persons and/or items within the environment 105, proximity sensors capable of detecting the presence of persons in the environment 105, and so forth.

The security service 125 performs computer vision on the imagery obtained by the visual sensors according to any suitable computer vision techniques. In some embodiments, the security service 125 performs facial recognition to identify various persons in the environment 105, such as one or more users 160 representing customers, visitors, guests, etc. of the environment 105, and/or one or more associates 170 representing persons having an affiliation with the operator of the environment 105, such as employees, contractors, vendors, etc. In some embodiments, the security service 125 accesses reference photos for the persons, e.g., stored in profiles 130 in the memory 120 and/or in a database controlled by the operator (e.g., external to the operator device 110), and compares the imagery with the reference photos to identify the persons. In some embodiments, the security service 125 may assign temporary identifiers to persons who are not positively identified from reference photos,and use the temporary identifiers when tracking the persons through the environment 105.

The one or more users 160 may possess a corresponding one or more user devices 165 (such as a handheld or wearable electronic device) that communicate with the LAN 140, and the one or more associates 170 may possess a corresponding one or more associate devices 175 that communicate with the LAN 140. In some embodiments, each of the user device(s) 165 and the associate device(s) 175 may connect to the LAN 140 directly (e.g., joining a wireless network originating within the environment 105) or indirectly through a WAN 180 (e.g., a cellular network). The WAN 180 is any wide area network (for example, the Internet) capable of communicating computer data over non-local distances by any technology for communicating computer data, now known or to be developed in the future. Similar to the LAN 140, the WAN 180 may include computer hardware such as copper transmission cables, optical transmission fibers, wireless transmission, routers, firewalls, switches, gateway computers, and/or edge servers.

In some embodiments, each of the user device(s) 165 and the associate device(s) 175 may include an application that communicates with the security service 125, which may be implemented as a dedicated application for the environment 105 or as a more general-purpose application such as a web browser. In some embodiments, each of the user device(s) 165 and the associate device(s) 175 includes a token (hardware and/or software-based) that is assigned specific to the person owning the device. In this way, the security service 125 may identify the person when their user device 165 or associate device 175 connects to the security service 125 through the LAN 140. This token-based identification may be performed alternate to facial recognition or may be performed in combination therewith.

The security service 125 performs object detection and/or image segmentation on the imagery obtained by the visual sensors to track movement of one or more body parts of the person, to identify one or more items handled by the person, and so forth. For example, the security service 125 may identify and/or track the head and hands of the person, the items handled by the person as they are carried or returned, receptacles used by the person (e.g., shopping carts, baskets, bags, boxes, and so forth).

The security service 125 assesses a behavior of the persons in the environment 105 using the computer vision. In some embodiments, assessing the behavior of a person comprises identifying one or more actions taken by the person, and determining whether the one or more actions correspond to any of a predetermined set of suspicious behaviors. The suspicious behaviors may include actions that are consistent with theft or unauthorized access by the person or by another person. In some embodiments, the predetermined set of suspicious behaviors includes some or all of: the person moving their hand(s) into an unauthorized receptacle (e.g., the security service 125 identifies the proximity of the hand(s) to the unauthorized receptacle, infers the location of the hand(s) as in the unauthorized receptacle despite occlusion within the captured imagery, and so forth), the person concealing an item within their clothing (e.g., placing an item into a pocket or within an outer garment) (e.g., the security service 125 infers the location of hand(s) or the item despite occlusion), the number and/or a composition of items handled by the person (e.g., an unusual quantity of cough medicine) (e.g., the security service 125 maintains a count of identified item(s) and compares with a threshold value and/or an interaction history of the person such as previous purchases), an amount of time spent by the person in a secure region (e.g., the security service 125 begins a timer when the person is identified as accessing the secure region, and compares the time to a threshold value and/or an interaction history of the person), the person turning their head (e.g., turning their head back and forth multiple times) (e.g., the security service 125 identifies the orientation of the person’s head relative to their torso and maintains a count of the person rotating their head more than a threshold angle, past a center line of the torso, and so forth), the person glancing at an associate or a visual sensor multiple times (e.g., the security service 125 identifies the orientation of the person’s head or eyes relative to the location of the associate or the visual sensor, and maintains a count of the person orienting their head or eyes toward the associate or the visual sensor, and so forth), the person handing an item to another person (e.g., the security service 125 identifies the proximity of the item to a first person, identifies the item and/or the hand increasing proximity to a second person, and identifies the proximity to the first person decreasing), and so forth.

Based on the behavior of the persons, the security service 125 dynamically calculates trust levels associated with the persons, which are used to determine whether the persons will be granted access to secure region(s) of the environment 105. In some embodiments, the security service 125 determines an initial value of the trust level at the beginning of the person’s session within the environment 105. For example, a session may begin when the person is first detected and identified by the security service 125 (e.g., facial recognition or token-based), or when the person logs in using an electronic device within the environment 105, such as a computer terminal.

In some embodiments, the initial value of the trust level is based on whether the person is registered with the operator of the environment 105. In some embodiments, a profile 130 for the person is stored in the memory 120 when the person has registered with the operator of the environment 105. The profile 130 may be implemented as a record that includes one or more fields for biographical information 132 for the person, such as a name, age, address, contact information (e.g., phone, email), reference photo, default payment information, and so forth. The profile 130 may further include one or more fields for external information 134 that has been authorized by the person during registration. For example, the security service 125 may connect through the WAN 180 to a social media service 185 to obtain information from a social media account associated with the person, and/or to a background check service 190 to obtain a background check of the person. The profile 130 may further include interaction records 136 that represent the person’s interactions within the environment 105 and/or within an associated environment (e.g., another store operated by the same operator). The interaction records 136 may include any suitable information, such as a timestamp, a location, the item(s) that the person interacted with, a characterization of the interaction (e.g., whether the interaction corresponded to a suspicious behavior), video of the interaction, and so forth. The profiles 130 for the associates 170 may have a different format than the profiles 130 for the users 160, and may include different fields such as a role of the associate 170, whether the role is supervisory, an experience of the associate 170, a performance rating, any special authorizations (restocking), and so forth.

The profile 130 of the person further includes a trust level 138 for the person that is dynamically calculated by the security service 125 based on the behavior of the person (e.g., while accessing secure regions within the environment 105), and that is further based on some or all of the other information within the profile 130. For example, the trust level 138 for a person may begin at a lesser value when the background check shows a significant criminal history, when compared to a background check with no criminal history. In another example, the trust level 138 may begin at a relatively greater value when the profile 130 includes more information (e.g., the person has provided more biographical information 132 and/or authorized more external information 134). In some embodiments, for those persons who are not positively identified, the security service 125 may assign temporary identifiers and store a trust level 138 in a temporary profile. The temporary profile may have a lower default value for the trust level 138 than a profile 130 that is linked to a positively-identified person.

When the trust level 138 is less than a threshold, the person will be denied access to secure region(s) of the environment 105. For example, a locked door or shelving unit may remain locked when the person approaches. The secure region(s) may share a same threshold, or may have different thresholds based on the items stored therein. For example, a secure region storing more expensive electronics (e.g., computers, televisions, video game systems) may have a threshold greater than another secure region storing less expensive electronics (e.g., radios, cell phone accessories).

In some embodiments, the security service 125 responsive to denying access displays a notification of the denied access to the person and/or to an associate 170. In some embodiments, the environment 105 includes one or more displays 150 that the security service 125 uses to provide a video and/or audio-based notification of the denied access, and in some cases may provide an explanation of the denied access. For example, to explain the denied access, the notification may include video from the interaction records 136 of the profile 130 showing the person having performed a suspicious behavior during the session that caused the trust level 138 to decrease below the threshold. The display(s) 150 may have any suitable implementation, such as monitors or terminals near the secure region(s) within the environment 105. In other embodiments, the security service 125 may send the notifications to the user device 165 and/or the associate device 175 to be displayed using the displays connected thereto or included therewith.

In some embodiments, the security service 125 displays the notification of the denied access to the person only. In other embodiments, the security service 125 displays the notification of the denied access to the associate 170, which may be in addition to or alternate to the person. For example, the notification may be transmitted to the associate device 175 when the trust level 138 of the person is less than a second threshold, when the secure region stores more expensive items (e.g., having a relatively greater threshold for access), and so forth.

In some embodiments, displaying the notification of the denied access further comprises presenting a remedial action to the person. Performing the remedial action will increase the trust level of the person, and in some embodiments, the remedial action is selected by the security service 125 to increase the trust level beyond the threshold. In some cases, the remedial action can correspond directly to correcting the suspicious behavior. For example, when the suspicious behavior is placing item(s) into an unapproved receptacle, the remedial action may include transferring the item(s) to an approved receptacle. In other cases, the remedial action need not correspond to a suspicious behavior, e.g., prompting the person to provide an input (e.g., at a touchscreen of the display 150) to acknowledge the notification or to provide further information about the person and/or the transaction.

As mentioned above, the security service 125 may dynamically update the trust level 138 for the person while accessing the secure region. In some embodiments, the trust level 138 may be increased (or remain constant) when the person does not perform any suspicious behaviors while accessing the secure region, and the trust level 138 may be decreased when the person performs one or more suspicious behaviors.

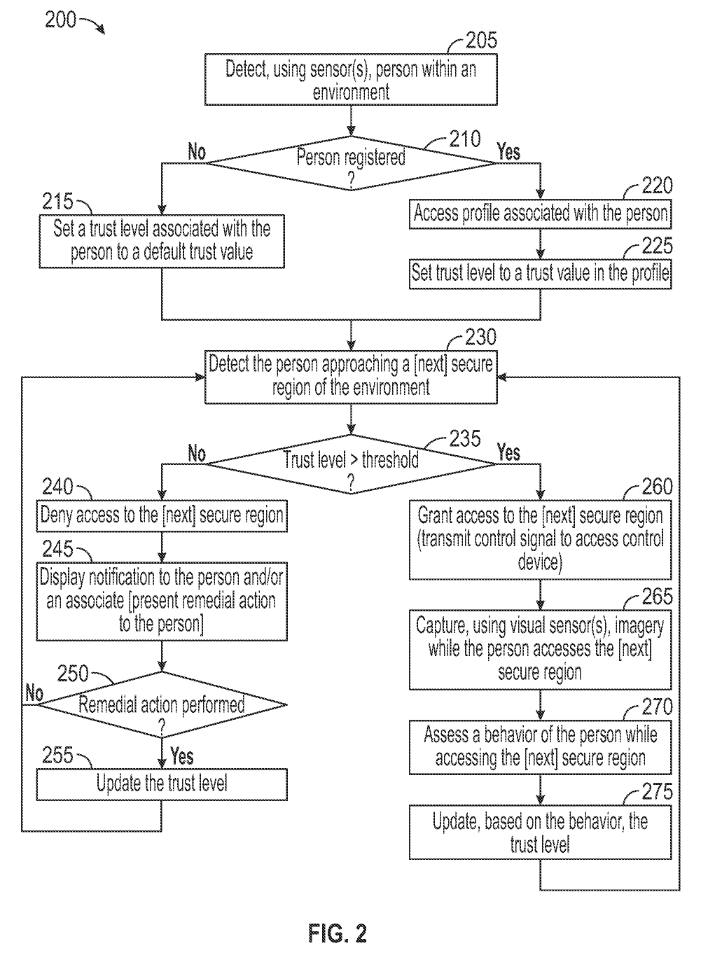

FIG. 2 is an exemplary method 200 of dynamically updating a trust level for a person based on behavior while accessing a secure region, according to one or more embodiments. The method 200 may be used in conjunction with other embodiments, e.g., may be performed using the security service 125 of FIG. 1.

The method 200 begins at block 205, where the security service 125 detects a person within the environment 105 using one or more sensors 145. The one or more sensors 145 may include one or more types of sensors, such as visual sensors, proximity sensors, and so forth. In some embodiments, detecting the person within the environment 105 comprises attempting to identify the person, e.g., using facial recognition processing and/or token based identification. The person may have any suitable role relative to the environment 105, such as a customer, visitor, guest, employee, vendor, and so forth. In some embodiments, the security service 125 assigns a temporary identifier to the person when not positively identified.

At block 210, the security service 125 determines whether the person is registered with an operator of the environment 105. In some embodiments, determining whether the person is registered comprises determining whether the memory 120 stores a profile 130 associated with the identity of the person (e.g., matching the biographical information 132).

If the security service 125 determines that the person is not registered (“NO”), flow proceeds from block 210 to block 215 and a trust level associated with the person is set to a default trust value. If the security service 125 determines that the person is registered (“YES”), flow proceeds from block 210 to block 220 and the security service 125 accesses the profile 130 associated with the person. At block 225, the security service 125 sets the trust level 138 to a trust value stored in a field of the profile 130.

Flow proceeds from block 215 or block 225 to block 230, where the security service 125 detects the person approaching a secure region of the environment 105. Detecting the person may be using any of the one or more sensors 145, which may be the same sensor(s) as used in block 205 to detect the person within the environment 105.

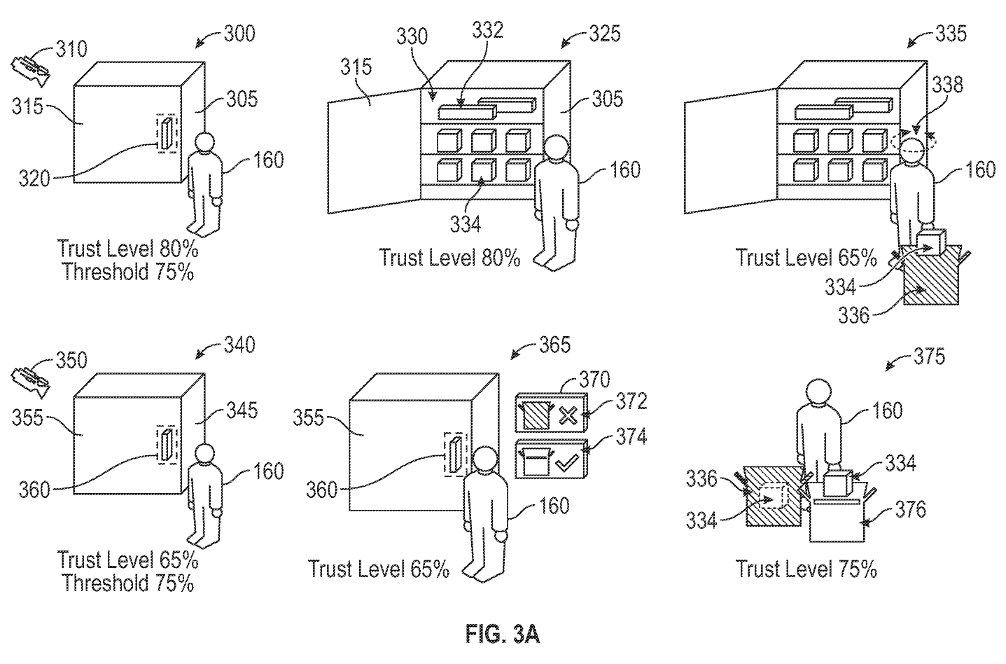

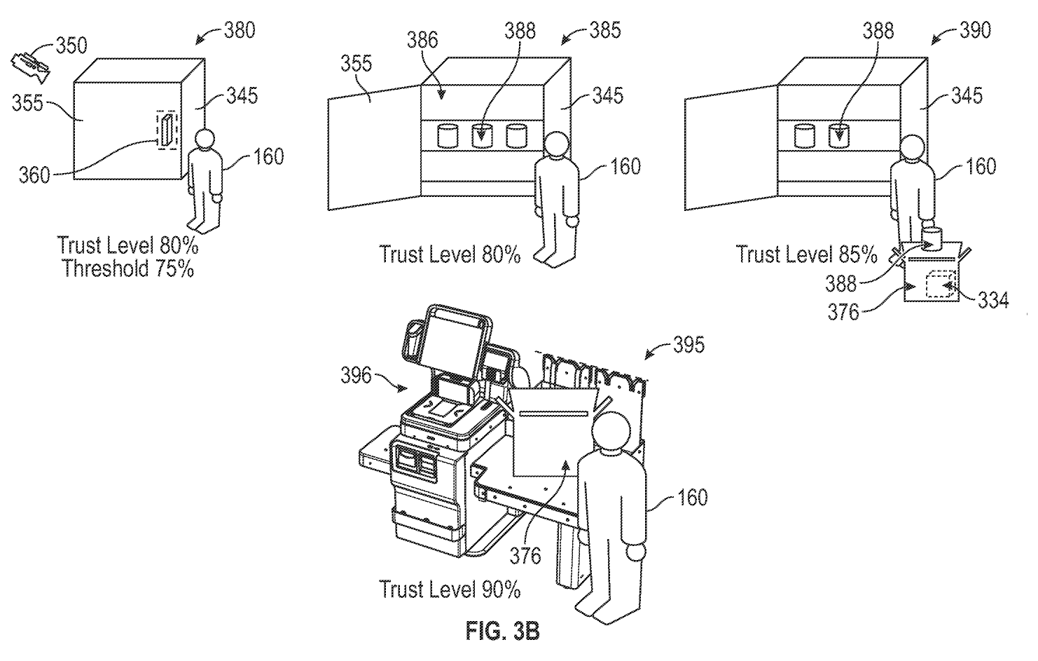

Refer also to diagram 300 of FIG. 3A, which with FIG. 3B illustrates an exemplary sequence of a person accessing secure regions within an environment. In the diagram 300, a camera 310 (representing one example of a visual sensor of the one or more sensors 145) is oriented toward a first secure region of the environment 105. The first secure region is depicted as an enclosed shelving unit 305 having a door 315.

A lock 320 (representing one example of an access control device 155) is operated by the security service 125 to grant or deny access to the first secure region. The lock 320 includes a motor that actuates a latch into and/or out of a detent of the enclosed shelving unit 305 (e.g., formed in the body or frame) or of its support structure (e.g., formed in a floor or support beneath). In some embodiments, the lock 320 has a normally closed configuration. The lock 320 further includes circuitry that operates the motor to actuate the latch (e.g., in a horizontal or vertical direction) to release the latch from the detent, thereby deactivating the lock 320 (an unlocked configuration) and allowing the user 160 to open the door 315 using its handle (e.g., rotation of the door 315 about its hinge(s)). In some embodiments, the enclosed shelving unit 305 further comprises an electromechanical hinge that actuates a pin to enable rotation of the door 315 about the hinge, and/or actuates the door 315. When the door 315 closes automatically or by action of the user 160, the lock 320 actuates the latch to engage the detent and thereby activate the lock 320 (a locked configuration). Other types of access control devices 155 are also contemplated for use in the enclosed shelving unit 305, such as an electromagnetic lock, an electric strike plate, a motorized sliding bolt, an electromechanical hinge, an actuable barrier, an actuable door or cover (or portion thereof), and so forth.

The camera 310 detects the user 160 approaching the enclosed shelving unit 305, e.g., as the user 160 enters the field of view of the camera 310. At block 235, the security service 125 determines whether the trust level 138 of the person is greater than a threshold. In the diagram 300, the user 160 begins with a trust level of 80%, and a first threshold for accessing the first secure region is 75%. When the trust level 138 is greater than the threshold (“YES”), as in the diagram 300, flow proceeds to block 260, and the security service 125 grants access to the first secure region. In some embodiments, granting access to the first secure region comprises transmitting a control signal to the access control device (e.g., the lock 320) that controls access to the first secure region. In some embodiments, the control signal operates the access control device to open the door 315 (e.g., unlocking and/or unlatching). In other embodiments, the control signal unlocks the door 315 but the user 160 must manipulate a handle or latch to open the door 315. In diagram 325, the door 315 has opened and an interior volume 330 of the enclosed shelving unit 305 is accessible to the user 160. A plurality of items 332, 334 are disposed within the interior volume 330, on shelves of the enclosed shelving unit 305.

At block 265, the secure service 125 captures imagery using one or more visual sensors (e.g., the camera 310) while the person accesses the first secure region. In some embodiments, the person accesses the first secure region when some or all of their body enters the interior volume 330. For example, the person may extend their hand or arm into the interior volume 330 when reaching for an item 334, or may walk into the interior volume of a different type of secure region such as a refrigerated room. In other embodiments, the person may access the first secure region when the items 334, 336 become accessible, without requiring the person to physically enter the interior volume 330. At block 270, the secure service 125 assesses a behavior of the person while accessing the first secure region.

In some embodiments, assessing the behavior of the person comprises performing object detection or image segmentation on the imagery to track movement of one or more body parts of the person, such as the head or hands of the person. In some embodiments, assessing the behavior of the person comprises one or both of: identifying a turning of a head of the person, and identifying movement of one or more hands of the person into or toward an unapproved receptacle.

In some embodiments, assessing the behavior of the person comprises performing object detection or image segmentation on the imagery to identify one or more items handled by the person, and identifying one or both of: a composition of the one or more items, and a count of an item type of the one or more items. Assessing the behavior of the person may further include the security service 125 tracking the one or more items through positive identification of the items depicted in the imagery (with associated location information) over time (e.g., across a plurality of frames), comparing the relative movement of the items to the one or more body parts of the person, inferring the location of the items when occluded within the imagery, assigning a confidence level to the location of the items, and so forth.

Assessing the behavior of the person may include further functions performed by the security service 125. In one example, the tracked movement and/or identified items are compared with reference information, such as item information and gesture information, that is stored in a database controlled by the operator (e.g., external to the operator device 110). In another example, the tracked movement and/or identified items (or the imagery itself) is provided to a model implemented in an electronic device and controlled by the operator (e.g., in the operator device 110 or external thereto).

In diagram 335, the user 160 removes an item 334 from the secure region, and places the item 334 into an unapproved receptacle 336 (e.g., a personally-owned bag). The user 160 also turns his or her head back and forth, as shown by reference number 338. The security service 125 assesses these behaviors as described above, identifying the item 334 and tracking the movement of the item 334 and/or body part(s) of the user 160, across a plurality of frames, as the user 160 moves the item 334 toward the unapproved receptacle 336. From this, the security service 125 may infer the location of the item 334 within the unapproved receptacle 336 although the item 334 may be occluded in the imagery.

At block 275, the security service 125 updates the trust level 138 based on the behavior. Updating the trust level 138 may include updating a profile 130 associated with the person and stored in the memory 120, updating a record (or portion thereof) stored in a database controlled by the operator, and so forth. In some embodiments, updating the trust level 138 comprises determining whether the behavior corresponds to any suspicious behavior(s). For example, the user 160 using the unapproved receptacle 336 and turning his or her head may each correspond to suspicious behaviors included in a predefined set, and the security service 125 reduces the trust level 138 of the user 160 from 80% to 65%. Flow may return from block 275 to either block 230 or block 235, where the trust level for the same or a next secure region is compared against a threshold.

In diagram 340, a camera 350 captures imagery of the user 160 as he or she approaches a second secure region. In another example, the second secure region includes a shelving unit 345 with a door 355 and lock 360. For purposes of this example, the door 355 and the lock 360 may be similar to the door 315 and lock 320 discussed above. At block 235, the security service 125 determines whether the trust level 138 of the person is greater than a threshold. In the diagram 340, the user 160 has a trust level of 65%, and a second threshold for accessing the second secure region is 75%.

As the trust level 138 is not greater than the threshold (“NO”), flow proceeds from block 235 to block 240, and the security service 125 denies access to the second secure region. In some embodiments, denying access to the second secure region comprises taking no action (e.g., allowing the lock 360 to remain in its normally-closed configuration). For example, the lock 360 may include a latch that normally engages a detent of the shelving unit to retain the door 355 in a closed configuration. The security service 125 denies access to the second secure region by controlling the lock 360 such that the latch remains engaged with the detent.

At block 245, the security service 125 generates a graphical notification of the denied access to the person and/or to an associate and displays the graphical notification on a display device. In some embodiments, displaying the notification of the denied access comprises generating a graphical depiction describing a remedial action to the person. In diagram 365, a monitor 370 (representing one example of the display(s) 150) arranged near the second enclosed shelving unit 345 displays a first display 372 illustrating problem(s) causing the denied access and/or a second display 374 illustrating the remedial action. In some embodiments, the security service 125 determines which problem(s) to display based on which was most recent, which caused the greatest decrease in the trust level 138, and so forth. Further, the security service 125 may determine with remedial action to display corresponding to at least one determined problem, based on which remedial action could increase the trust level 138 beyond the threshold (or corresponds to a greatest increase), and so forth.

As shown, the first display 372 generates a graphical depiction that describes the use of the unapproved receptacle 336 as the problem causing the denied access. The second display 374 displays the use of an approved receptacle 376 (e.g., a store-provided bag, basket, or cart) as the remedial action, suggesting to the user 160 that the user 160 remove the item(s) from the unapproved receptacle 336. Other forms of presentation of the problem and/or the remedial action are also contemplated, such as text or audio instructions (which may be in combination with displaying graphical elements), playing video of the suspicious behavior(s), and so forth.

At block 250, the security service 125 determines whether the remedial action was performed. When the user has not performed the remedial action (“NO”), flow returns to block 230. When the user has performed the remedial action (“YES”), flow proceeds to block 255 and the trust level 138 is updated. In diagram 375, the user 160 moves the item 334 from the unapproved receptacle 336 into the approved receptacle 376. As a result, the security service 125 updates the trust level 135 from 65% to 80%.

Flow returns from block 255 to block 230 or to block 235. In diagram 380 of FIG. 3B, the user 160 again approaches the second secure region. At block 235, the security service 125 determines that the trust level 138 of the person is greater than a threshold. In the diagram 380, the user 160 has a trust level of 80% which is greater than the second threshold of 75%. Flow proceeds to block 260, and the security service 125 grants access to the second secure region. In some embodiments, the security service 125 grants access to the second secure region by controlling the lock 360 to actuate the latch, releasing the latch from the detent and allowing the user 160 to open the door 355 of the shelving unit 345.

In diagram 385, the door 355 has opened and an interior volume 386 of the second enclosed shelving unit 345 is accessible to the user 160. A plurality of items 388 are disposed within the interior volume 386, on shelves of the enclosed shelving unit 345. In diagram 390, the user 160 removes an item 388 and places it into the approved receptacle 376. The security service 125 increases the trust level 138 from 80% to 85%, e.g., as described above with respect to block 275.

In some embodiments, the security service 125 updates the trust level 138 of the user 160 each time the user 160 accesses a secure region during the session in the environment 105. In some embodiments, the security service 125 may also update the trust level 138 responsive to other events during the session and/or at completion of the session. For example, diagram 395 illustrates the user 160 at a checkout area 396 of the environment 105. When the user 160 successfully presents payment or otherwise completes the transaction for the selected items within the approved receptacle 376, the security service 125 may further increase the trust level 138 from 85% to 90%.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method comprising:
detecting, using one or more sensors, a person within an environment;
determining, responsive to determining that the person is registered with an operator of the environment, a first trust value for a trust level associated with the person; and
responsive to determining that the first trust value is greater than a predetermined threshold, transmitting a control signal to an access control device that is attached to a door or cover and that controls access to the first secure region,
wherein the control signal comprises an instruction causing the access control device to actuate a latch in a direction that releases the latch from a detent associated with the first secure region, enabling movement of the door or cover relative to the trust level meeting the predetermined threshold.

2. The computer-implemented method of claim 1, further comprising:
assessing, using imagery captured by one or more visual sensors, a behavior of the person while accessing the first secure region, wherein assessing the behavior of the person while accessing the first secure region comprises performing object detection or image segmentation on the imagery to track movement of one or more body parts of the person; and
updating, based on the behavior of the person while accessing the first secure region, the trust level to a second trust value.

3. The computer-implemented method of claim 2, wherein assessing the behavior of the person while accessing the first secure region further comprises one or both of:
identifying a turning of a head of the person; and
identifying movement of one or more hands of the person into or toward an unapproved receptacle.

4. The computer-implemented method of claim 1, wherein assessing the behavior of the person while accessing the first secure region comprises:
performing object detection or image segmentation on the imagery to identify one or more items handled by the person; and
identifying one or both of: a composition of the one or more items, and a count of an item type of the one or more items.

5. The computer-implemented method of claim 1, wherein determining the first trust value for the trust level comprises:
accessing, responsive to determining that the person is registered with the operator of the environment, a profile associated with the person that is stored in a database controlled by the operator, wherein the profile includes one or more fields for information obtained from one or both of: a social media account of the person, and a background check of the person.

6. The computer-implemented method of claim 1, further comprising:
denying, when the second trust value is less than the threshold, access to a second secure region of the environment; and
displaying a notification of the denied access to one or both of: the person, and an associate of the environment.

7. The computer-implemented method of claim 6, wherein displaying the notification of the denied access comprises presenting a remedial action to the person, the method further comprising:
updating, responsive to determining that the person performed the remedial action, the trust level to a third trust value that is greater than the threshold.

8. A computer system comprising:
one or more processors;
one or more computer-readable storage media; and
program instructions stored on the one or more computer-readable storage media to cause the one or more processors to perform operations comprising:
detecting, using one or more sensors, a person within an environment;
determining, responsive to determining that the person is registered with an operator of the environment, a first trust value for a trust level associated with the person; and
responsive to determining that the first trust value is greater than a predetermined threshold, transmitting a control signal to an access control device that is attached to a door or cover and that controls access to the first secure region,
wherein the control signal comprises an instruction causing the access control device to actuate a latch in a direction that releases the latch from a detent associated with the first secure region, enabling movement of the door or cover relative to the trust level meeting the predetermined threshold.

9. The computer system of claim 8, further comprising:
assessing, using imagery captured by one or more visual sensors, a behavior of the person while accessing the first secure region, wherein assessing the behavior of the person while accessing the first secure region comprises performing object detection or image segmentation on the imagery to track movement of one or more body parts of the person; and
updating, based on the behavior of the person while accessing the first secure region, the trust level to a second trust value.

10. The computer system of claim 9, wherein assessing the behavior of the person while accessing the first secure region further comprises one or both of:
identifying a turning of a head of the person; and
identifying movement of one or more hands of the person into or toward an unapproved receptacle.

11. The computer system of claim 8, wherein assessing the behavior of the person while accessing the first secure region comprises:
performing object detection or image segmentation on the imagery to identify one or more items handled by the person; and
identifying one or both of: a composition of the one or more items, and a count of an item type of the one or more items.

12. The computer system of claim 8, wherein determining the first trust value for the trust level comprises:
accessing, responsive to determining that the person is registered with the operator of the environment, a profile associated with the person that is stored in a database controlled by the operator, wherein the profile includes one or more fields for information obtained from one or both of: a social media account of the person, and a background check of the person.

13. The computer system of claim 8, the operations further comprising:
denying, when the second trust value is less than the threshold, access to a second secure region of the environment; and
displaying a notification of the denied access to one or both of: the person, and an associate of the environment.

14. The computer system of claim 13, wherein displaying the notification of the denied access comprises presenting a remedial action to the person, the operations further comprising:
updating, responsive to determining that the person performed the remedial action, the trust level to a third trust value that is greater than the threshold.

15. A computer program product comprising:
one or more computer-readable storage media; and
program instructions stored on the one or more computer-readable storage media to perform operations comprising:
detecting, using one or more sensors, a person within an environment;
determining, responsive to determining that the person is registered with an operator of the environment, a first trust value for a trust level associated with the person; and
responsive to determining that the first trust value is greater than a predetermined threshold, transmitting a control signal to an access control device that is attached to a door or cover and that controls access to the first secure region,
wherein the control signal comprises an instruction causing the access control device to actuate a latch in a direction that releases the latch from a detent associated with the first secure region, enabling movement of the door or cover relative to the trust level meeting the predetermined threshold.

16. The computer program product of claim 15, the operations further comprising:
assessing, using imagery captured by one or more visual sensors, a behavior of the person while accessing the first secure region, wherein assessing the behavior of the person while accessing the first secure region comprises performing object detection or image segmentation on the imagery to track movement of one or more body parts of the person; and
updating, based on the behavior of the person while accessing the first secure region, the trust level to a second trust value.

17. The computer program product of claim 16, wherein assessing the behavior of the person while accessing the first secure region further comprises one or both of:
identifying a turning of a head of the person; and
identifying movement of one or more hands of the person into or toward an unapproved receptacle.

18. The computer program product of claim 15, wherein assessing the behavior of the person while accessing the first secure region comprises:
performing object detection or image segmentation on the imagery to identify one or more items handled by the person; and
identifying one or both of: a composition of the one or more items, and a count of an item type of the one or more items.

19. The computer program product of claim 15, wherein determining the first trust value for the trust level comprises:
accessing, responsive to determining that the person is registered with the operator of the environment, a profile associated with the person that is stored in a database controlled by the operator, wherein the profile includes one or more fields for information obtained from one or both of: a social media account of the person, and a background check of the person.

20. The computer program product of claim 15, the operations further comprising:
denying, when the second trust value is less than the threshold, access to a second secure region of the environment; and
displaying a notification of the denied access to one or both of: the person, and an associate of the environment.
